(19) United States
(12) Patent Application Publication
(10) Pub. No.: US 2026/0331397 A1
(43) Pub. Date: Oct. 22, 2026

(54) SPACE KEY DEVICE

(71) Applicant: Sunrex Technology Corp., Taichung City (TW)

(72) Inventors: Yin CHU, Chongqing City (CN); Bao-Song MA, Chongqing City (CN); Shih-Pin LIN, Taichung City (TW)

(73) Assignee: Sunrex Technology Corp., Taichung City (TW)

(21) Appl. No.: 19/302,505

(22) Filed: Aug. 18, 2025

(30) Foreign Application Priority Data
Apr. 16, 2025 (TW) 114203774

(51) Int. Cl. H01H 13/14; H01H 13/10

(52) U.S. Cl. CPC H01H 13/14; H01H 13/10

(57) ABSTRACT

A space key device includes a base plate, a thin film circuit board disposed on the plate body, a resilient member disposed on the thin film circuit board, a keycap disposed on the resilient member, and a scissor mechanism unit disposed between the plate body and the keycap. A balance rod set has a front balance rod and a rear balance rod that interconnect the plate body and the keycap. A reinforcement rod set has a front reinforcement rod and a rear reinforcement rod that interconnect the plate body and the keycap. The front reinforcement rod is disposed forwardly of the front balance rod. The rear reinforcement rod is disposed rearwardly of the rear balance rod. An intermediate reinforcement member is mounted to the keycap and disposed between the front balance rod and the rear balance rod.

### CROSS-REFERENCE TO RELATED APPLICATION

This application claims priority to Taiwanese Utility Model Patent Application No. 114203774, filed on Apr. 16, 2025, the entire disclosure of which is incorporated by reference herein.

### FIELD

The disclosure relates to an input device, and more particularly to a space key device.

### BACKGROUND

As notebook computers continue to be slimmer and lighter, a keyboard height of a notebook computer has to be reduced as well. For example, a space key of a keyboard has a base plate extending in a lengthwise direction, a thin film circuit board disposed on the base plate, a resilient member disposed on the thin film circuit board, a keycap disposed on the resilient member, two scissor mechanisms pivotally interconnecting the keycap and the base plate, and two balance rods extending in the lengthwise direction and pivotally interconnecting the keycap and the base plate.

Because a length to width ratio of the space key is relatively large, structural strength of its keycap is relatively weak. When a user presses a non-central portion of the keycap, the keycap may be deformed, thereby affecting accuracy of a triggering signal. By virtue of the two reinforcement balance rods, the structural strength and stability of movement of the keycap may be increased. However, a thickness of the keycap is 0.6 mm, which causes an overall height of the space key to be greater than 3.6 mm. As a result, an entire height of the keyboard is greater than 3.6 mm, thereby failing to meet an industry requirement of the keyboard height being smaller than 3.6 mm.

### SUMMARY

Therefore, an object of the disclosure is to provide a space key device that can alleviate at least one of the drawbacks of the prior art.

According to the disclosure, the space key device includes a base plate, a thin film circuit board, a resilient member, a keycap, a scissor mechanism unit, and a balance reinforcement unit.

The base plate includes a plate body, two front left hooks, two rear left hooks, two front right hooks, two rear right hooks, a first left blocking member, a first right blocking member, a second left blocking member, and a second right blocking member. The plate body is elongated in a left-right direction. The two front left hooks are disposed on the plate body. The two rear left hooks are disposed on the plate body. The two front right hooks are disposed on the plate body. The two rear right hooks are disposed on the plate body. The first left blocking member is disposed on the plate body, and has a front opening and a rear opening formed at an intersection of the first left blocking member and the plate body. The first right blocking member is disposed on the plate body, and has a front opening and a rear opening formed at an intersection of the first right blocking member and the plate body. The second left blocking member and the second right blocking member are disposed on the plate body and are disposed between the first left blocking member and the first right blocking member. The second left blocking member has a front opening and a rear opening which are formed at an intersection of the second left blocking member and the plate body. The second right blocking member has a front opening and a rear opening which are formed at an intersection of the second right blocking member and the plate body.

The thin film circuit board is elongated in the left-right direction and disposed on a top plate surface of the plate body.

The resilient member is disposed on a top film surface of the thin film circuit board and extends upwardly.

The keycap is disposed on a top end of the resilient member, and includes a keycap body plate, two front left pivotal seats, two rear left pivotal seats, two front right pivotal seats, two rear right pivotal seats, a plurality of first front pivotal seats, a plurality of first rear pivotal seats, a plurality of second front pivotal seats, a plurality of second rear pivotal seats, and a plurality of intermediate pivotal seats. The keycap body plate has a top plate surface and a bottom plate surface spaced apart from the top plate surface in a top-bottom direction that is perpendicular to the left-right direction. A distance between the top plate surface and the bottom plate surface in the top-bottom direction is not larger than 0.5 mm. The two front left pivotal seats are disposed on the bottom plate surface. The two rear left pivotal seats are disposed on the bottom plate surface. The two front right pivotal seats are disposed on the bottom plate surface. The two rear right pivotal seats are disposed on the bottom plate surface. The plurality of first front pivotal seats are disposed on the bottom plate surface and are arranged in the left-right direction. The plurality of first rear pivotal seats are disposed on the bottom plate surface and are arranged in the left-right direction. The plurality of second front pivotal seats are disposed on the bottom plate surface, are arranged in the left-right direction, and are disposed adjacent to and at a rear side of the plurality of the first front pivotal seats. The plurality of second rear pivotal seats are disposed on the bottom plate surface, are arranged in the left-right direction, and are disposed adjacent to and at a front side of the plurality of the first rear pivotal seats. The plurality of intermediate pivotal seats are disposed on the bottom plate surface and are disposed between the plurality of second front pivotal seats and the plurality of second rear pivotal seats.

The scissor mechanism unit includes a first scissor mechanism and a second scissor mechanism. The first scissor mechanism is pivotally connected among the two front left pivotal seats, the two rear left pivotal seats, the two front left hooks, and the two rear left hooks. The second scissor mechanism is pivotally connected among the two front right pivotal seats, the two rear right pivotal seats, the two front right hooks, and the two rear right hooks.

The balance reinforcement unit includes a balance rod set, a reinforcement rod set, and an intermediate reinforcement member. The balance rod set has a front balance rod and a rear balance rod. The front balance rod has an elongated balance rod body which extends in the left-right direction and which is pivotally engaged with the plurality of first front pivotal seats, a left balance rod body and a right balance rod body which extend respectively and rearwardly from opposite ends of the elongated balance rod body of the front balance rod, a left balance insertion portion which extends rightwardly from the left balance rod body of the front balance rod and which is inserted into the front opening of the first left blocking member, and a right balance insertion portion which extends leftwardly from the right balance rod body of the front balance rod and which is inserted into the front opening of the first right blocking member. The rear balance rod has an elongated balance rod body which extends in the left-right direction and which is pivotally connected to the plurality of first rear pivotal seats, a left balance rod body and a right balance rod body which extend respectively and forwardly from opposite ends of the elongated balance rod body of the rear balance rod, a left balance insertion portion which extends rightwardly from the left balance rod body of the rear balance rod and which is inserted into the rear opening of the first left blocking member, and a right balance insertion portion which extends leftwardly from the right balance rod body of the rear balance rod and which is inserted into the rear opening of the first right blocking member. The reinforcement rod set has a front reinforcement rod and a rear reinforcement rod. The front reinforcement rod has a main reinforcement rod body which extends in the left-right direction and which is pivotally connected to the plurality of second front pivotal seats, a left reinforcement rod body and a right reinforcement rod body which extend respectively and rearwardly from opposite ends of the main reinforcement rod body of the front reinforcement rod, a left reinforcement insertion portion which extends leftwardly from the left reinforcement rod body of the front reinforcement rod and which is inserted into the front opening of the second left blocking member, and a right reinforcement insertion portion which extends rightwardly from the right reinforcement rod body of the front reinforcement rod and which is inserted into the front opening of the second right blocking member. The rear reinforcement rod has a main reinforcement rod body which extends in the left-right direction and which is pivotally connected to the plurality of second rear pivotal seats, a left reinforcement rod body and a right reinforcement rod body which extend respectively and forwardly from opposite ends of the main reinforcement rod body of the rear reinforcement rod, a left reinforcement insertion portion which extends leftwardly from the left reinforcement rod body of the rear reinforcement rod and which is inserted into the rear opening of the second left blocking member, and a right reinforcement insertion portion which extends rightwardly from the right reinforcement rod body of the rear reinforcement rod and which is inserted into the rear opening of the second right blocking member. The intermediate reinforcement member is mounted between the plurality of intermediate pivotal seats.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a space key device according to an embodiment of the disclosure.

FIG. 2 is a partly schematic perspective view of the embodiment illustrating the space key device.

FIG. 3 is an exploded perspective view of the embodiment illustrating a base plate, a thin film circuit board, a resilient member, a keycap, a scissor mechanism unit, and a balance reinforcement unit of the space key device.

FIG. 4 is a perspective view of the embodiment illustrating the base plate.

FIG. 5 is a schematic fragmentary view of the embodiment illustrating the base plate.

FIG. 6 is an exploded perspective view of the embodiment illustrating a balance rod set and a reinforcement rod set of the balance reinforcement unit.

FIG. 7 is a schematic fragmentary perspective view of the embodiment illustrating the scissor mechanism unit, the balance rod set, and a reinforcement rod set being assembled to the base plate.

FIG. 8 is a schematic fragmentary enlarged perspective view of a portion of FIG. 7.

FIG. 9 is another schematic fragmentary enlarged perspective view of a portion of FIG. 7.

FIG. 10 is a schematic sectional view taken along line X-X of FIG. 1.

FIG. 11 is a schematic sectional view taken along line XI-XI of FIG. 1.

FIG. 12 is a schematic sectional view taken along line XII-XII of FIG. 1.

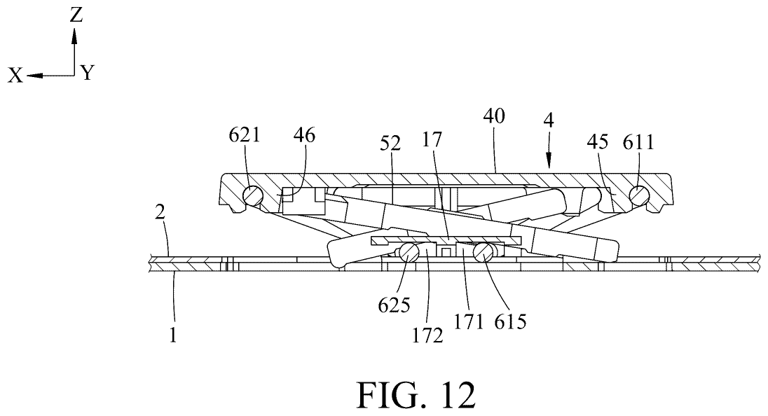

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

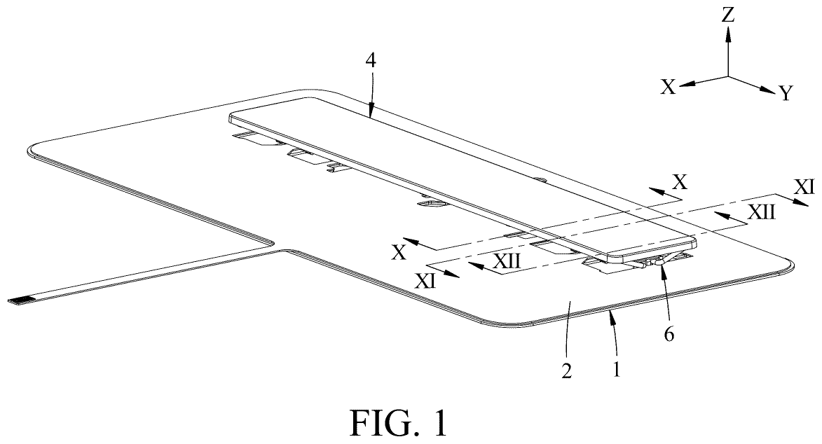

FIGS. 1 to 3 illustrate a space key device adapted to be mounted in a laptop computer keyboard (not shown) according to an embodiment of the disclosure. The space key device of the disclosure includes a base plate 1, a thin film circuit board 2, a resilient member 3, a keycap 4, a scissor mechanism unit 5, and a balance reinforcement unit 6.

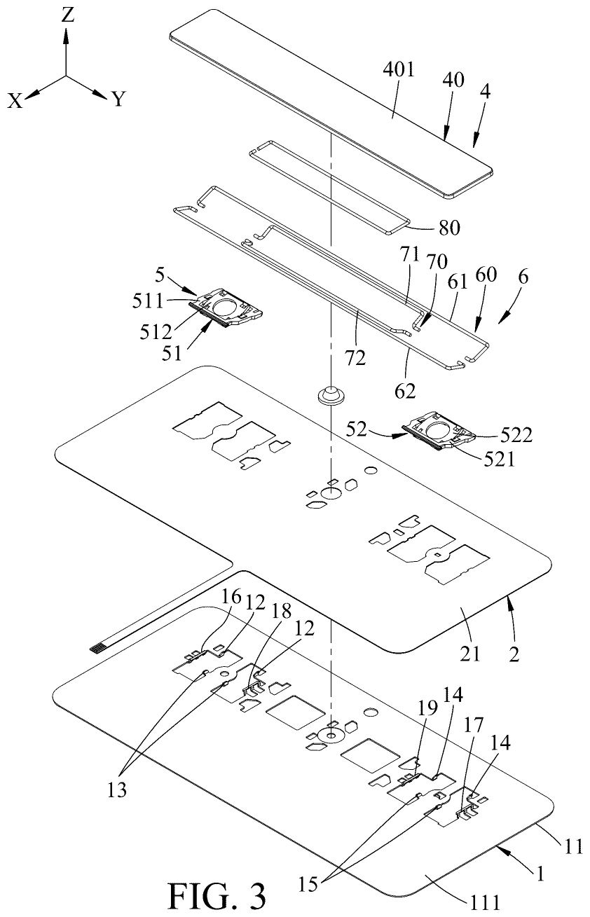

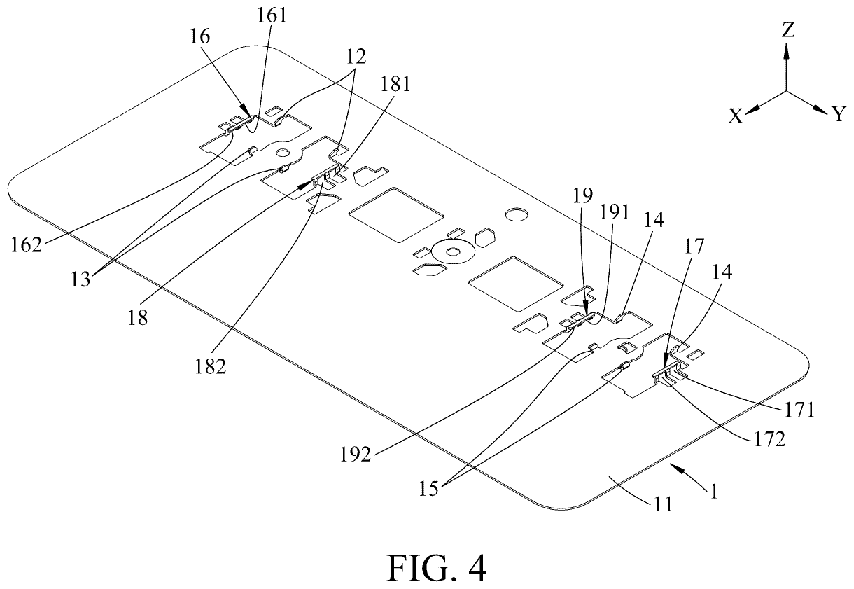

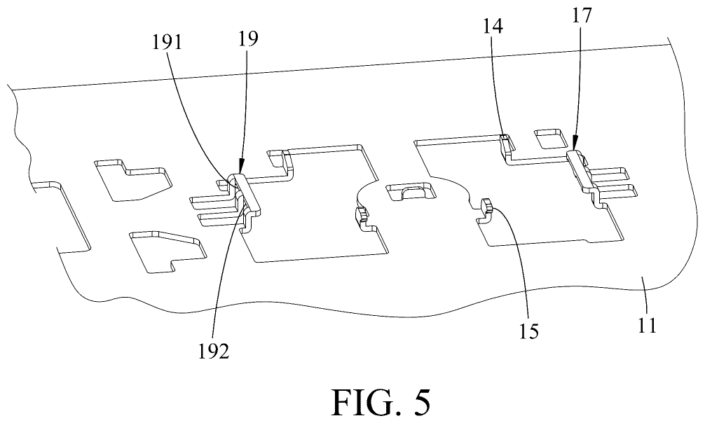

Referring to FIGS. 4 and 5 in combination with FIG. 3, the base plate 1 includes a plate body 11, two front left hooks 12, two rear left hooks 13, two front right hooks 14, two rear right hooks 15, a first left blocking member 16, a first right blocking member 17, a second left blocking member 18, and a second right blocking member 19. The plate body 11 is elongated in a left-right direction (Y) which is the same as a lengthwise direction of the base plate 1. The two front left hooks 12 are disposed on the plate body 11. The two rear left hooks 13 are disposed on the plate body 11 and are disposed rearwardly of the two front left hooks 12 in a front-rear direction (X) perpendicular to the left-right direction (Y). The two front right hooks 14 are disposed on the plate body 11. The two rear right hooks 15 are disposed on the plate body 11 and are disposed rearwardly of the two front right hooks 14 in the front-rear direction (X). The first left blocking member 16 is disposed on the plate body 11. The first right blocking member 17 is disposed on the plate body 11. The second left blocking member 18 and the second right blocking member 19 are disposed on the plate body 11 and are disposed between the first left blocking member 16 and the first right blocking member 17. The second left blocking member 18 is disposed rightwardly of the first left blocking member 16 in the left-right direction (Y). The second right blocking member 19 is disposed leftwardly of the first right blocking member 17 in the left-right direction (Y). The first left blocking member 16 extends upwardly from the plate body 11 and has an inverted L-shaped cross section on an imaginary plane extending in the left-right direction (Y) and a top-bottom direction (Z) perpendicular to the left-right direction (Y) and the front-rear direction (X). The first left blocking member 16 has a front opening 161 and a rear opening 162 which are formed at an intersection of the first left blocking member 16 and the plate body 11, which extend through the first left blocking member 16 in the left-right direction (Y), and each of which is L-shaped. The first right blocking member 17 extends upwardly from the plate body 11 and has an inverted L-shaped cross section on an imaginary plane extending in the left-right direction (Y) and the top-bottom direction (Z). The first right blocking member 17 has a front opening 171 and a rear opening 172 which are formed at an intersection of the first right blocking member 17 and the plate body 11, which extend through the first right blocking member 17 in the left-right direction (Y), and each of which is L-shaped. The second left blocking member 18 extends upwardly from the plate body 11 and has an inverted L-shaped cross section on an imaginary plane extending in the left-right direction (Y) and the top-bottom direction (Z). The second left blocking member 18 has a front opening 181 and a rear opening 182 which are formed at an intersection of the second left blocking member 18 and the plate body 11, which extend through the second left blocking member 18 in the left-right direction (Y), and each of which is L-shaped. The second right blocking member 19 extends upwardly from the plate body 11 and has an inverted L-shaped cross section on an imaginary plane extending in the left-right direction (Y) and the top-bottom direction (Z). The second right blocking member 19 has a front opening 191 and a rear opening 192 which are formed at an intersection of the second right blocking member 19 and the plate body 11, which extend through the second right blocking member 19 in the left-right direction (Y), and each of which is L-shaped.

The thin film circuit board 2 is elongated in the left-right direction (Y) and disposed on a top plate surface 111 of the plate body 11.

The resilient member 3 is disposed on a top film surface 21 of the thin film circuit board 2 and extends upwardly.

As shown in FIGS. 1, 2, and 3, the keycap 4 is disposed on a top end of the resilient member 3, and includes a keycap body plate 40, two front left pivotal seats 41, two rear left pivotal seats 42, two front right pivotal seats 43, two rear right pivotal seats 44, a plurality of first front pivotal seats 45, a plurality of first rear pivotal seats 46, a plurality of second front pivotal seats 47, a plurality of second rear pivotal seats 48, and a plurality of intermediate pivotal seats 49. The keycap body plate 40 has a top plate surface 401 and a bottom plate surface 402 spaced apart from the top plate surface 401 in the top-bottom direction (Z). A distance between the top plate surface 401 and the bottom plate surface 402 in the top-bottom direction (Z) is not larger than 0.5 mm. The two front left pivotal seats 41 are disposed on the bottom plate surface 402. The two rear left pivotal seats 42 are disposed on the bottom plate surface 402. The two front right pivotal seats 43 are disposed on the bottom plate surface 402. The two rear right pivotal seats 44 are disposed on the bottom plate surface 402. The plurality of first front pivotal seats 45 are disposed on the bottom plate surface 402 and are arranged in the left-right direction (Y). The plurality of first rear pivotal seats 46 are disposed on the bottom plate surface 402 and are arranged in the left-right direction (Y). The plurality of second front pivotal seats 47 are disposed on the bottom plate surface 402, are arranged in the left-right direction (Y), and are disposed adjacent to and at a rear side of the plurality of the first front pivotal seats 45. The plurality of second rear pivotal seats 48 are disposed on the bottom plate surface 402, are arranged in the left-right direction (Y), and are disposed adjacent to and at a front side of the plurality of the first rear pivotal seats 46. The plurality of intermediate pivotal seats 49 are disposed on the bottom plate surface 402 and are disposed between the plurality of second front pivotal seats 47 and the plurality of second rear pivotal seats 48.

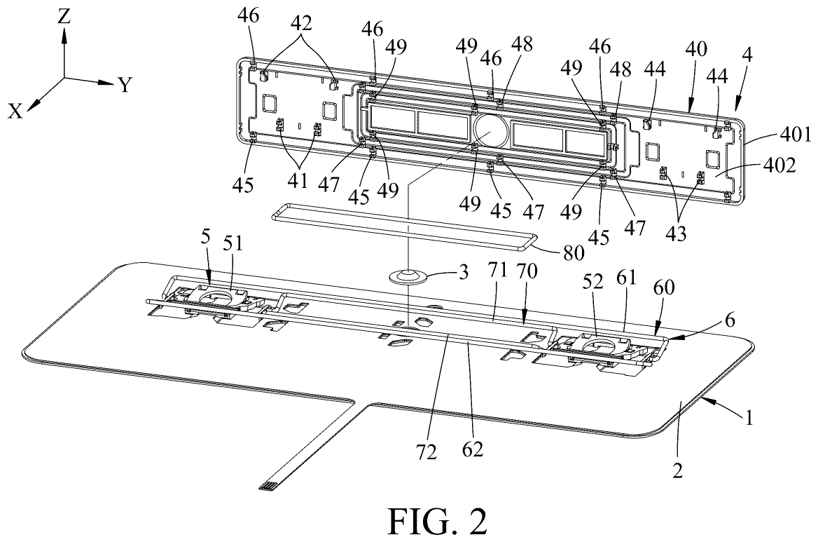

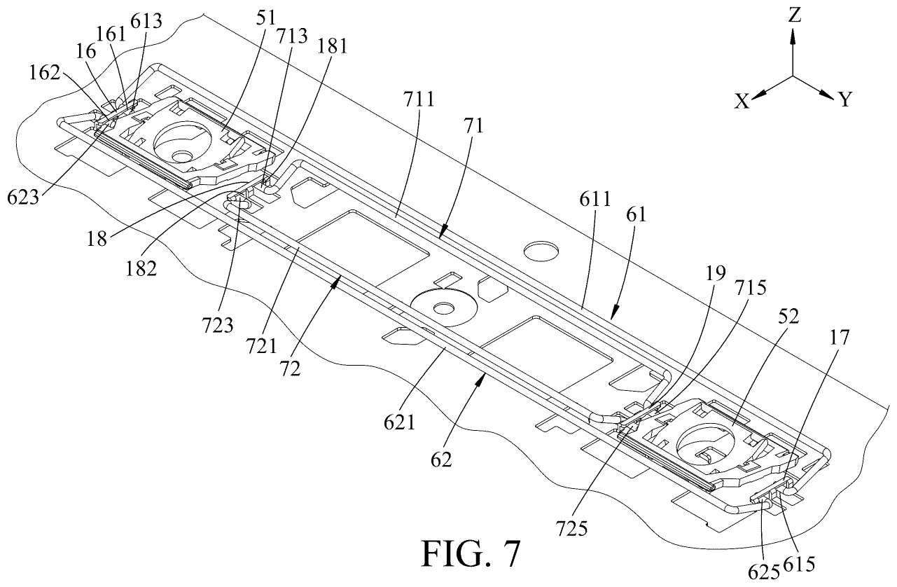

Referring to FIG. 7 in combination FIGS. 2 and 3, the scissor mechanism unit 5 includes a first scissor mechanism 51 and a second scissor mechanism 52. The first scissor mechanism 51 is pivotally connected among the two front left pivotal seats 41, the two rear left pivotal seats 42, the two front left hooks 12, and the two rear left hooks 13. The second scissor mechanism 52 is pivotally connected among the two front right pivotal seats 43, the two rear right pivotal seats 44, the two front right hooks 14, and the two rear right hooks 15. In this embodiment, the first scissor mechanism 51 has an outer bracket 511 and an inner bracket 512 disposed in and pivotally connected to the outer bracket 511. The outer bracket 511 of the first scissor mechanism 51 is pivotally connected to the two front left hooks 12 of the base plate 1 and the two rear left pivotal seats 42 of the keycap 4. The inner bracket 512 of the first scissor mechanism 51 is pivotally connected to the two rear left hooks 13 of the base plate 1 and the two front left pivotal seats 41 of the keycap 4. The second scissor mechanism 52 has an outer bracket 521 and an inner bracket 522 disposed in and pivotally connected to the outer bracket 521. The outer bracket 521 of the second scissor mechanism 52 is pivotally connected to the two front right hooks 14 of the base plate 1 and the two rear right pivotal seats 44 of the keycap 4. The inner bracket 522 of the second scissor mechanism 52 is pivotally connected to the two rear right hooks 15 of the base plate 1 and the two front right pivotal seats 43 of the keycap 4.

With reference back to FIGS. 1, 2, and 3, the balance reinforcement unit 6 includes a balance rod set 60, a reinforcement rod set 70, and an intermediate reinforcement member 80.

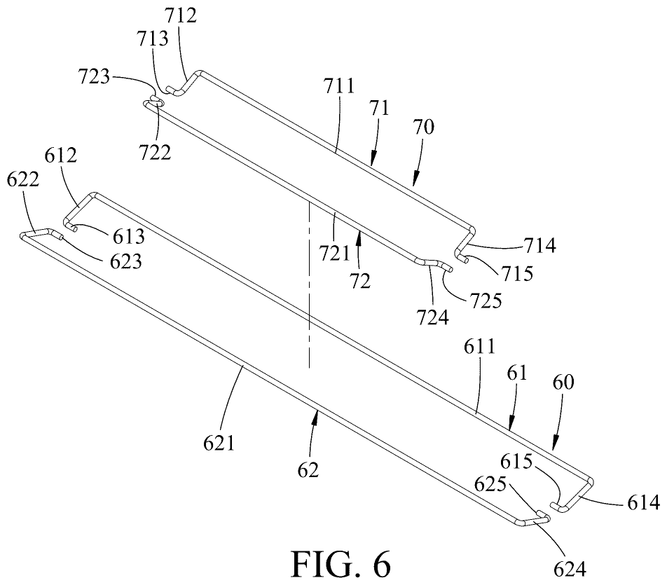

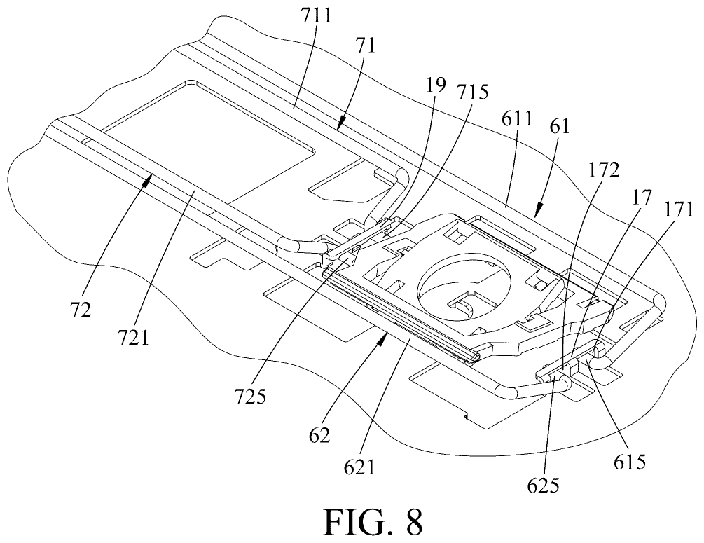

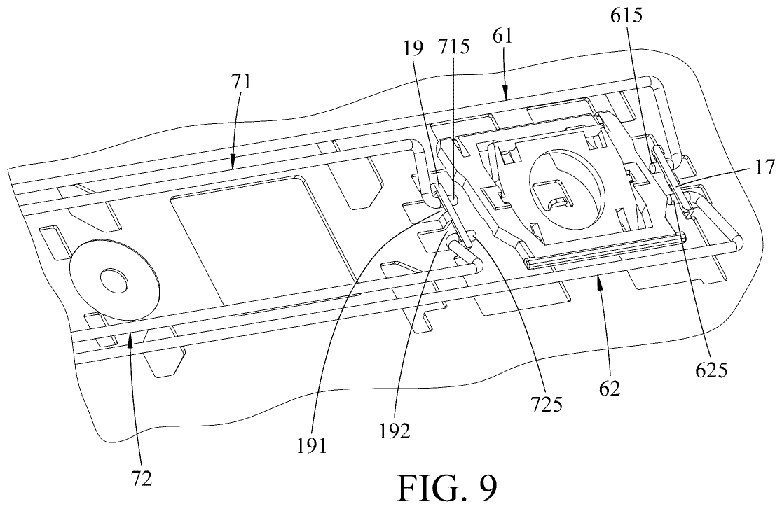

As shown in FIGS. 6 to 10, the balance rod set 60 has a front balance rod 61 and a rear balance rod 62.

The front balance rod 61 has an elongated balance rod body 611, a left balance rod body 612, a right balance rod body 614, a left balance insertion portion 613, and a right balance insertion portion 615. The elongated balance rod body 611 of the front balance rod 61 extends in the left-right direction (Y) and is pivotally engaged with and rotatable relative to the plurality of first front pivotal seats 45. The left balance rod body 612 and the right balance rod body 614 extend respectively and rearwardly from opposite ends of the elongated balance rod body 611 of the front balance rod 61. The left balance insertion portion 613 extends rightwardly from the left balance rod body 612 of the front balance rod 61 and is inserted into the front opening 161 of the first left blocking member 16. The right balance insertion portion 615 extends leftwardly from the right balance rod body 614 of the front balance rod 61 and is inserted into the front opening (171) of the first right blocking member 17.

The rear balance rod 62 has an elongated balance rod body 621, a left balance rod body 622, a right balance rod body 624, a left balance insertion portion 623, and a right balance insertion portion 625. The elongated balance rod body 621 extends in the left-right direction (Y) and is pivotally connected to and rotatable relative to the plurality of first rear pivotal seats 46. The left balance rod body 622 and the right balance rod body 624 extend respectively and forwardly from opposite ends of the elongated balance rod body 621 of the rear balance rod 62. The left balance insertion portion 623 extends rightwardly from the left balance rod body 622 of the rear balance rod 62 and is inserted into the rear opening 162 of the first left blocking member 16. The right balance insertion portion 625 extends leftwardly from the right balance rod body 624 of the rear balance rod 62 and is inserted into the rear opening 172 of the first right blocking member 17.

The reinforcement rod set 70 has a front reinforcement rod 71 and a rear reinforcement rod 72.

The front reinforcement rod 71 has a main reinforcement rod body 711, a left reinforcement rod body 712, a right reinforcement rod body 714, a left reinforcement insertion portion 713, and a right reinforcement insertion portion 715. The main reinforcement rod body 711 extends in the left-right direction (Y) and is pivotally connected to and rotatable relative to the plurality of second front pivotal seats 47. The left reinforcement rod body 712 and the right reinforcement rod body 714 extend respectively and rearwardly from opposite ends of the main reinforcement rod body 711 of the front reinforcement rod 71. The left reinforcement insertion portion 713 extends leftwardly from the left reinforcement rod body 712 of the front reinforcement rod 71 and is inserted into the front opening 181 of the second left blocking member 18. The right reinforcement insertion portion 715 extends rightwardly from the right reinforcement rod body 714 of the front reinforcement rod 71 and is inserted into the front opening 191 of the second right blocking member 19.

The rear reinforcement rod 72 has a main reinforcement rod body 721, a left reinforcement rod body 722, a right reinforcement rod body 724, a left reinforcement insertion portion 723, and a right reinforcement insertion portion 725. The main reinforcement rod body 721 extends in the left-right direction (Y) and is pivotally connected to and rotatable relative to the plurality of second rear pivotal seats 48. The left reinforcement rod body 722 and the right reinforcement rod body 724 extend respectively and forwardly from opposite ends of the main reinforcement rod body 721 of the rear reinforcement rod 72. The left reinforcement insertion portion 723 extends leftwardly from the left reinforcement rod body 722 of the rear reinforcement rod 72 and is inserted into the rear opening 182 of the second left blocking member 18. The right reinforcement insertion portion 725 extends rightwardly from the right reinforcement rod body 724 of the rear reinforcement rod 72 and is inserted into the rear opening 192 of the second right blocking member 19.

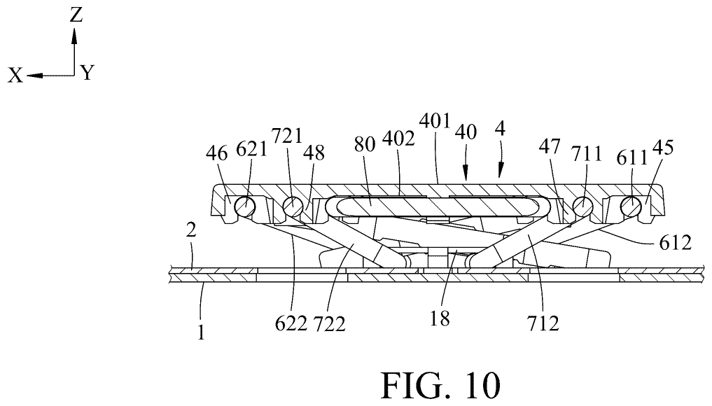

As shown in FIGS. 2 and 10, the intermediate reinforcement member 80 is mounted between the plurality of intermediate pivotal seats 49, thereby being positioned to the bottom plate surface 402 of the keycap body plate 40. In this embodiment, the intermediate reinforcement member 80 is hollow and has a rectangular shape.

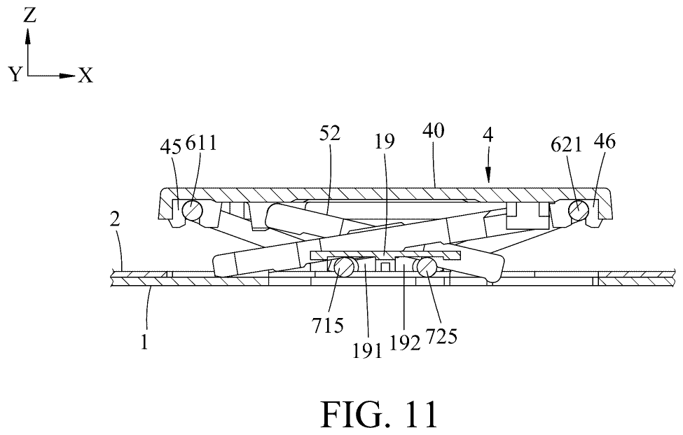

Referring to FIGS. 1, 2, 9, and 11, the balance reinforcement unit 6 may strengthen a structure of the keycap 4. An entire thickness of the keycap 4 in the top-bottom direction (Z) may be reduced because the distance between the top plate surface 401 and the bottom plate surface 402 of the keycap body plate 40 in the top-bottom direction (Z) is not larger than 0.5 mm. As a result, when a user presses the keycap 4, the keycap 4 may remain horizontal and stably move toward the thin film circuit board 2. Specifically, the elongated balance rod body 611 of the front balance rod 61 is disposed adjacent to a front edge of the keycap body plate 40 of the keycap 4 in the left-right direction (Y), and the elongated balance rod body 621 of the rear balance rod 62 is disposed adjacent to a rear edge of the keycap body plate 40 of the keycap 4 in the left-right direction (Y), so the front edge and the rear edge of the keycap body plate 40 of the keycap 4 are supported. The main reinforcement rod body 711 of the front reinforcement rod 71 is disposed adjacent to the front edge of the keycap body plate 40 of the keycap 4 in the left-right direction (Y) and is disposed rearwardly of the elongated balance rod body 611 of the front balance rod 61. The main reinforcement rod body 721 of the rear reinforcement rod 72 is disposed adjacent to the rear edge of the keycap body plate 40 of the keycap 4 in the left-right direction (Y) and is disposed forwardly of the elongated balance rod body 621 of the rear balance rod 62. As a result, a front region and a rear region of the keycap body plate 40 of the keycap 4 in the left-right direction (Y) are supported. The intermediate reinforcement member 80 is disposed between the front region and the rear region of the keycap body plate 40 of the keycap 4, so a middle region of the keycap body plate 40 of the keycap 4 is supported. By virtue of the balance rod set 60, the reinforcement rod set 70, and the intermediate reinforcement member 80, the keycap body plate 40 may be entirely supported and the structure of the keycap body plate 40 may be strengthened, so the distance between the top plate surface 401 and the bottom plate surface 402 of the keycap body plate 40 in the top-bottom direction (Z) may be reduced to be smaller than or equal to 0.5 mm.

When the keycap 4 is pressed, the first scissor mechanism 51 and the second scissor mechanism 52 of the scissor mechanism unit 5, the balance rod set 60, and the reinforcement rod set 70 may allow the keycap 4 to remain horizontal and stably move toward the thin film circuit board 2. Although the distance between the top plate surface 401 and the bottom plate surface 402 of the keycap body plate 40 in the top-bottom direction (Z) is reduced to be smaller than or equal to 0.5 mm, the structural strength of the keycap 4 remains, and the keycap 4 is not likely to be deformed.

In addition, when the keycap 4 is pressed, the front balance rod 61 and the rear balance rod 62 are driven to rotatably move away from each other. As the left balance insertion portion 613 of the front balance rod 61 and the left balance insertion portion 623 of the rear balance rod 62 abut against a top end of the first left blocking member 16, and as the right balance insertion portion 615 of the front balance rod 61 and the right balance insertion portion 625 of the rear balance rod 62 abut against a top end of the first right blocking member 17, the rotation of the front balance rod 61 and the rotation of the rear balance rod 62 are limited. Because each of the first left blocking member 16 and the first right blocking member 17 has the inverted L-shaped cross section on the imaginary plane extending in the left-right direction (Y) and the top-bottom direction (Z), the structure of each of the first left blocking member 16 and the first right blocking member 17 may be strengthened, a contact area between the left balance insertion portion 613 of the front balance rod 61 and the first left blocking member 16 and a contact area between the left balance insertion portion 623 of the rear balance rod 62 and the first left blocking member 16 are increased, and a contact area between the right balance insertion portion 615 of the front balance rod 61 and the first right blocking member 17 and a contact area between the right balance insertion portion 625 of the rear balance rod 62 and the first right blocking member 17 are increased. As a result, the first left blocking member 16 and the first right blocking member 17 may avoid deformation caused by concentrated forces, thereby reducing the failure rate.

Likewise, when the keycap 4 is pressed, the front reinforcement rod 71 and the rear reinforcement rod 72 are driven to rotatably move away from each other. As the left reinforcement insertion portion 713 of the front reinforcement rod 71 and the left reinforcement insertion portion 723 of the rear reinforcement rod 72 abut against a top end of the second left blocking member 18, and as the right reinforcement insertion portion 715 of the front reinforcement rod 71 and the right reinforcement insertion portion 725 of the rear reinforcement rod 72 abut against a top end of the second right blocking member 19, the rotation of the front reinforcement rod 71 and the rotation of the rear reinforcement rod 72 are limited. Because each of the second left blocking member 18 and the second right blocking member 19 has the inverted L-shaped cross section on an imaginary plane extending in the left-right direction (Y) and the top-bottom direction (Z), the structure of each of the second left blocking member 18 and the second right blocking member 19 may be strengthened, a contact area between the left reinforcement insertion portion 713 of the front reinforcement rod 71 and the second left blocking member 18 and a contact area between the left reinforcement insertion portion 723 of the rear reinforcement rod 72 and the second left blocking member 18 are increased, and a contact area between the right reinforcement insertion portion 715 of the front reinforcement rod 71 and the second right blocking member 19 and a contact area between the right reinforcement insertion portion 725 of the rear reinforcement rod 72 and the second right blocking member 19 are increased. As a result, the second left blocking member 18 and the second right blocking member 19 may avoid deformation caused by the concentrated forces, thereby reducing the failure rate.

The space key device of the disclosure has the following effects and advantages.
1. The balance rod set 60, the reinforcement rod set 70, and the intermediate reinforcement member 80 of the balance reinforcement unit 6 provide good support to the keycap 4, thereby effectively strengthening the structure of the key cap 4. When the distance between the top plate surface 401 and the bottom plate surface 402 of the keycap body plate 40 in the top-bottom direction (Z) is reduced to be smaller than or equal to 0.5 mm, when being pressed, the keycap 4 may remain horizontal and stably move toward the thin film circuit board 2. As a result, a total height of the space key device in the top-bottom direction (Z) is reduced to be smaller than 3.6 mm, so a total height of the laptop computer keyboard (not shown) in the top-bottom direction (Z) may be reduced to be smaller than 3.6 mm. In practice, the total height of the space key device in the top-bottom direction (Z) is 3.4 mm, such that the total height of the laptop computer keyboard (not shown) in the top-bottom direction (Z) is 3.4 mm, which meets an industry requirement.
2. Because each of the first left blocking member 16 and the first right blocking member 17 has the inverted L-shaped cross section on an imaginary plane extending in the left-right direction (Y) and the top-bottom direction (Z), deformation of each of the first left blocking member 16 and the first right blocking member 17 may be avoided, thereby reducing the failure rate.
3. Because each of the second left blocking member 18 and the second right blocking member 19 has the inverted L-shaped cross section on an imaginary plane extending in the left-right direction (Y) and the top-bottom direction (Z), deformation of each of the second left blocking member 18 and the second right blocking member 19 may be avoided, thereby reducing the failure rate.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A space key device adapted to be mounted in a laptop computer keyboard, said space key device comprising:
a base plate including
a plate body that is elongated in a left-right direction,
two front left hooks that are disposed on said plate body,
two rear left hooks that are disposed on said plate body,
two front right hooks that are disposed on said plate body,
two rear right hooks that are disposed on said plate body,
a first left blocking member that is disposed on said plate body, and that has a front opening and a rear opening formed at an intersection of said first left blocking member and said plate body,
a first right blocking member that is disposed on said plate body, and that has a front opening and a rear opening formed at an intersection of said first right blocking member and said plate body, and
a second left blocking member and a second right blocking member that are disposed on said plate body and that are disposed between said first left blocking member and said first right blocking member, said second left blocking member having a front opening and a rear opening which are formed at an intersection of said second left blocking member and said plate body, said second right blocking member having a front opening and a rear opening which are formed at an intersection of said second right blocking member and said plate body;
a thin film circuit board being elongated in the left-right direction and disposed on a top plate surface of said plate body;
a resilient member disposed on a top film surface of said thin film circuit board and extending upwardly;
a keycap disposed on a top end of said resilient member, and including
a keycap body plate that has a top plate surface and a bottom plate surface spaced apart from said top plate surface in a top-bottom direction that is perpendicular to the left-right direction, a distance between said top plate surface and said bottom plate surface in the top-bottom direction being not larger than 0.5 mm,
two front left pivotal seats that are disposed on said bottom plate surface,
two rear left pivotal seats that are disposed on said bottom plate surface,
two front right pivotal seats that are disposed on said bottom plate surface,
two rear right pivotal seats that are disposed on said bottom plate surface,
a plurality of first front pivotal seats that are disposed on said bottom plate surface and that are arranged in the left-right direction,
a plurality of first rear pivotal seats that are disposed on said bottom plate surface and that are arranged in the left-right direction,
a plurality of second front pivotal seats that are disposed on said bottom plate surface, that are arranged in the left-right direction, and that are disposed adjacent to and at a rear side of said plurality of said first front pivotal seats,
a plurality of second rear pivotal seats that are disposed on said bottom plate surface, that are arranged in the left-right direction, and that are disposed adjacent to and at a front side of said plurality of said first rear pivotal seats, and
a plurality of intermediate pivotal seats that are disposed on said bottom plate surface and that are disposed between said plurality of second front pivotal seats and said plurality of second rear pivotal seats;
a scissor mechanism unit including
a first scissor mechanism that is pivotally connected among said two front left pivotal seats, said two rear left pivotal seats, said two front left hooks, and said two rear left hooks, and
a second scissor mechanism that is pivotally connected among said two front right pivotal seats, said two rear right pivotal seats, said two front right hooks, and said two rear right hooks; and
a balance reinforcement unit including
a balance rod set that has
a front balance rod having an elongated balance rod body which extends in the left-right direction and which is pivotally engaged with said plurality of first front pivotal seats, a left balance rod body and a right balance rod body which extend respectively and rearwardly from opposite ends of said elongated balance rod body of said front balance rod, a left balance insertion portion which extends rightwardly from said left balance rod body of said front balance rod and which is inserted into said front opening of said first left blocking member, and a right balance insertion portion which extends leftwardly from said right balance rod body of said front balance rod and which is inserted into said front opening of said first right blocking member, and
a rear balance rod having an elongated balance rod body which extends in the left-right direction and which is pivotally connected to said plurality of first rear pivotal seats, a left balance rod body and a right balance rod body which extend respectively and forwardly from opposite ends of said elongated balance rod body of said rear balance rod, a left balance insertion portion which extends rightwardly from said left balance rod body of said rear balance rod and which is inserted into said rear opening of said first left blocking member, and a right balance insertion portion which extends leftwardly from said right balance rod body of said rear balance rod and which is inserted into said rear opening of said first right blocking member,
a reinforcement rod set that has
a front reinforcement rod having a main reinforcement rod body which extends in the left-right direction and which is pivotally connected to said plurality of second front pivotal seats, a left reinforcement rod body and a right reinforcement rod body which extend respectively and rearwardly from opposite ends of said main reinforcement rod body of said front reinforcement rod, a left reinforcement insertion portion which extends leftwardly from said left reinforcement rod body of said front reinforcement rod and which is inserted into said front opening of said second left blocking member, and a right reinforcement insertion portion which extends rightwardly from said right reinforcement rod body of said front reinforcement rod and which is inserted into said front opening of said second right blocking member, and
a rear reinforcement rod having a main reinforcement rod body which extends in the left-right direction and which is pivotally connected to said plurality of second rear pivotal seats, a left reinforcement rod body and a right reinforcement rod body which extend respectively and forwardly from opposite ends of said main reinforcement rod body of said rear reinforcement rod, a left reinforcement insertion portion which extends leftwardly from said left reinforcement rod body of said rear reinforcement rod and which is inserted into said rear opening of said second left blocking member, and a right reinforcement insertion portion which extends rightwardly from said right reinforcement rod body of said rear reinforcement rod and which is inserted into said rear opening of said second right blocking member, and
an intermediate reinforcement member that is mounted between said plurality of intermediate pivotal seats.

2. The space key device as claimed in claim 1, wherein each of said first left blocking member and said first right blocking member has an inverted L-shaped cross section on an imaginary plane extending in the left-right direction and the top-bottom direction.

3. The space key device as claimed in claim 2, wherein each of said second left blocking member and said second right blocking member has an inverted L-shaped cross section on an imaginary plane extending in the left-right direction and the top-bottom direction.

4. The space key device as claimed in claim 1, wherein each of said second left blocking member and said second right blocking member has an inverted L-shaped cross section on an imaginary plane extending in the left-right direction and the top-bottom direction.

5. The space key device as claimed in claim 1, wherein said intermediate reinforcement member is hollow and has a rectangular shape.
